(19) United States
(12) Patent Application Publication
(10) Pub. No.: US 2023/0215074 A1
(43) Pub. Date: Jul. 6, 2023

(54) RENDERING WORKLOAD MANAGEMENT FOR EXTENDED REALITY

(71) Applicant: META PLATFORMS TECHNOLOGIES, LLC, Menlo Park, CA (US)

(72) Inventor: Eugene Gorbatov, Sammamish, WA (US)

(21) Appl. No.: 17/567,793

(22) Filed: Jan. 3, 2022

(51) Int. Cl. G06T 15/00

(52) U.S. Cl. CPC G06T 15/005

(57) ABSTRACT

A method by a computing system of a device includes receiving a request to render a frame comprising one or more virtual content and determining, for the one or more virtual content, an associated characteristic. The method further includes determining whether to reduce a rendering workload associated with rendering the frame to satisfy one or more power or thermal constraints associated with the device. In response to a determination to reduce the rendering workload, the method further includes generating a set of rending parameters for rendering the frame in order to reduce the rendering workload. At least one rendering parameter in the set of rendering parameters is determined based on the characteristic associated with the one or more virtual content. The method thus includes rendering the frame in accordance with the set of rending parameters so as to satisfy the one or more power or thermal constraints.

### TECHNICAL FIELD

This disclosure relates generally to extended reality (XR) environments, and, more particularly, to rendering workload management for XR environments.

### BACKGROUND

An extended reality (XR) system may generally include a real-world environment that includes XR content overlaying one or more features of the real-world environment. In typical XR systems, image data may be rendered on, for example, a robust head-mounted display (HMD) that may be coupled through a physical wired or wireless connection to a base graphics generation device responsible for generating the image data. However, in some instances, in which the HMD includes, for example, lightweight XR glasses and/or other wearable electronic devices as opposed to more robust headset devices, the XR glasses or other lightweight wearable electronic devices may, in comparison, include reduced processing power, low-resolution cameras, and/or relatively simple tracking optics. Additionally, due to the smaller architectural area, the XR glasses or other lightweight wearable electronic devices may also include reduced power management and capability (e.g., batteries, battery size) and thermal management (e.g., cooling fans, heat sinks) electronics. This may often preclude such devices from maximizing performance while reducing power consumption and thermal impact. It may be thus useful to provide techniques to improve XR systems.

### SUMMARY OF PARTICULAR EMBODIMENTS

The present embodiments are directed toward various rendering workload management techniques that may be utilized by a device for reducing the processing capacity, power consumption, and thermal impact as the device renders and displays frames to a user. In particular embodiments, a computing system of the device may receive a request to render a frame including one or more virtual content. For example, in particular embodiments, the computing system of the device may receive the request to render the frame by receiving the request from a second device communicatively coupled to the device. In particular embodiments, the computing system of the device may then determine, for each of the one or more virtual content, an associated characteristic. For example, in particular embodiments, the computing system of the device may determine, for each of the one or more virtual content, the associated characteristic by determining one or more of a foveal region, an object dimension, or a viewing distance. In particular embodiments, the computing system of the device may then determine whether to reduce a rendering workload associated with rendering the frame to satisfy one or more power or thermal constraints associated with the device. In particular embodiments, in response to a determination to reduce the rendering workload, the computing system of the device may then generate a set of rending parameters for rendering the frame in order to reduce the rendering workload. In particular embodiments, at least one rendering parameter in the set of rendering parameters may be determined based on the characteristic associated with at least one of the one or more virtual content. For example, in particular embodiments, the computing system of the device may generate the set of rendering parameters by generating one or more of an altered viewport, an altered frame rate, an altered resolution, an altered bit depth, an altered one or more color channels, an altered pose update threshold, an altered depth continuity, an altered content range, an altered depth density, an altered near-field depth, an altered far-field depth, an altered brightness, an altered contrast, or an altered tone, rendering complexity (e.g., of an object that starts with a 3D object and then reduce shading complexity, use lower LOD and scale down to 2D representation). In particular embodiments, the computing system of the device may then render the frame in accordance with the set of rending parameters so as to satisfy the one or more power or thermal constraints.

In particular embodiments, a computing system of the device may receive a request to render a frame including one or more virtual content. In particular embodiments, the computing system of the device may generate a prediction of a duration for rendering the frame based on a current rendering workload of the device and one or more power or thermal constraints associated with the device. In particular embodiments, the computing system of the device may then select one of a plurality of predetermined rendering workload modes based on the prediction of the duration for rendering the frame. Specifically, the computing system of the device may predict workload duration, determine what level of performance may be supported given constraints, and then determine the appropriate mode suitable for the performance capacity. In particular embodiments, the computing system of the device may then render the frame in accordance with the selected one of the plurality of predetermined rendering workload modes so as to satisfy the one or more power or thermal constraints. For example, in particular embodiments, the plurality of predetermined rendering workload modes may include a high performance rendering workload mode, a medium performance workload processing mode, and a low performance rendering workload mode.

In particular embodiments, a computing system of the device may receive a request to render a frame including one or more virtual content. In particular embodiments, the device may include one or more first processors and a second device associated with the device may include one or more second processors. In particular embodiments, the computing system of the device may determine a rendering workload associated with rendering the frame to satisfy one or more power or thermal constraints associated with the device and a target quality of service (QoS) associated with the device and the second device. In one embodiment, the target QoS may be determined based on usage and/o the application, and then QoS that may be delivered by rendering the workload on the first processor and second processor given their capabilities and current constraints. In particular embodiments, the computing system of the device may then dynamically switch between rendering the frame utilizing the one or more first processors and rendering the frame utilizing the one or more second processors based on the one or more power or thermal constraints and the target QoS.

Thus, in accordance with the foregoing embodiments, the present techniques may provide various rendering workload management techniques that may be utilized by a device for reducing the processing capacity, power consumption, and thermal impact as the device renders and displays frames to a user. For example, the present techniques may be provided to alter parameters of the rendering workload of the device and to determine when, and the manner in which, to alter parameters of the rendering workload of the device in accordance with predetermined processing capacity constraints, power consumption constraints, and thermal constraints. In this way, the device pipeline may be optimized to operate at the highest energy efficiency level and may reduce overall power consumption and thermal impact by dynamically managing the rendering workload.

The embodiments disclosed herein are only examples, and the scope of this disclosure is not limited to them. Certain embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subj ect-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example extended reality (XR) system.

FIG. 2 illustrates a detailed embodiment of an extended reality (XR) system with an available network connection.

FIG. 3 illustrates is a flow diagram of a method for providing rendering workload management techniques for reducing processing capacity, power consumption, and thermal impact of a device based on generating a set of rending parameters for rendering a frame in order to reduce the rendering workload.

FIG. 4A illustrates is a flow diagram of a method for providing rendering workload management techniques for reducing processing capacity, power consumption, and thermal impact of a device based on generating a prediction of a duration for rendering a frame.

FIG. 4B illustrates is a flow diagram of a method for providing rendering workload management techniques for reducing processing capacity, power consumption, and thermal impact of a device based on dynamically switching GPUs for rendering a frame.

FIG. 5 illustrates an example network environment associated with a social-networking system.

FIG. 6 illustrates an example computer system.

### DESCRIPTION OF EXAMPLE EMBODIMENTS

An extended reality (XR) system may generally include a real-world environment that includes XR content overlaying one or more features of the real-world environment. In typical XR systems, image data may be rendered on, for example, a robust head-mounted display (HMD) that may be coupled through a physical wired or wireless connection to a base graphics generation device responsible for generating the image data. However, in some instances, in which the HMD includes, for example, lightweight XR glasses and/or other wearable electronic devices as opposed to more robust headset devices, the XR glasses or other lightweight wearable electronic devices may, in comparison, include reduced processing power, low-resolution cameras, and/or relatively simple tracking optics. Additionally, due to the smaller architectural area, the XR glasses or other lightweight wearable electronic devices may also include reduced power management and capability (e.g., batteries, battery size) and thermal management and capability (e.g., cooling fans, heat sinks) electronics. Indeed, given small form factor, the fact that devices are on the user's head and may be exposed to highly challenging environment conditions (e.g., direct sun light, etc.), the devices' power and thermal capability and thus performance capabilities is both constrained and dynamic in nature. This may often preclude such devices from maximizing performance while reducing power consumption and thermal impact. It may be thus useful to provide techniques to improve XR systems.

Accordingly, the present embodiments are directed toward various rendering workload management techniques that may be utilized by a device for reducing the processing capacity, power consumption, and thermal impact as the device renders and displays frames to a user. In particular embodiments, a computing system of the device may receive a request to render a frame including one or more virtual content. For example, in particular embodiments, the computing system of the device may receive the request to render the frame by receiving the request from a second device communicatively coupled to the device. In particular embodiments, the computing system of the device may then determine, for each of the one or more virtual content, an associated characteristic. For example, in particular embodiments, the computing system of the device may determine, for each of the one or more virtual content, the associated characteristic by determining one or more of a foveal region, an object dimension, or a viewing distance. In particular embodiments, the computing system of the device may then determine whether to reduce a rendering workload associated with rendering the frame to satisfy one or more power or thermal constraints associated with the device. In particular embodiments, in response to a determination to reduce the rendering workload, the computing system of the device may then generate a set of rending parameters for rendering the frame in order to reduce the rendering workload. In particular embodiments, at least one rendering parameter in the set of rendering parameters may be determined based on the characteristic associated with at least one of the one or more virtual content. For example, in particular embodiments, the computing system of the device may generate the set of rendering parameters by generating one or more of an altered viewport, an altered frame rate, an altered resolution, an altered bit depth, an altered one or more color channels, an altered pose update threshold, an altered depth continuity, an altered content range, an altered depth density, an altered near-field depth, an altered far-field depth, an altered brightness, an altered contrast, or an altered tone. In particular embodiments, the computing system of the device may then render the frame in accordance with the set of rending parameters so as to satisfy the one or more power or thermal constraints.

In particular embodiments, a computing system of the device may receive a request to render a frame including one or more virtual content. In particular embodiments, the computing system of the device may generate a prediction of a duration for rendering the frame based on a current rendering workload of the device and one or more power or thermal constraints associated with the device.. In particular embodiments, the computing system of the device may then select one of a plurality of predetermined rendering workload modes based on the prediction of the duration for rendering the frame. In particular embodiments, the computing system of the device may then render the frame in accordance with the selected one of the plurality of predetermined rendering workload modes so as to satisfy the one or more power or thermal constraints. Specifically, the computing system of the device may predict workload duration, determine what level of performance may be supported given constraints, and then determine the appropriate mode suitable for the performance capacity. For example, in particular embodiments, the plurality of predetermined rendering workload modes may include a high performance rendering workload mode, a medium performance workload processing mode, and a low performance rendering workload mode.

In particular embodiments, a computing system of the device may receive a request to render a frame including one or more virtual content. In particular embodiments, the device may include one or more first processors and a second device associated with the device may include one or more second processors. In particular embodiments, the computing system of the device may determine a rendering workload associated with rendering the frame to satisfy one or more power or thermal constraints associated with the device and a target quality of service (QoS) associated with the device and the second device. In particular embodiments, the computing system of the device may then dynamically switch between rendering the frame utilizing the one or more first processors and rendering the frame utilizing the one or more second processors based on the one or more power or thermal constraints and the target QoS.

Thus, in accordance with the foregoing embodiments, the present techniques may provide various rendering workload management techniques that may be utilized by a device for reducing the processing capacity, power consumption, and thermal impact as the device renders and displays frames to a user. For example, the present techniques may be provided to alter parameters of the rendering workload of the device and to determine when, and the manner in which, to alter parameters of the rendering workload of the device in accordance with predetermined processing capacity constraints, power consumption constraints, and thermal constraints. In this way, the device pipeline may be optimized to operate at the highest energy efficiency level and may reduce overall power consumption and thermal impact by dynamically managing the rendering workload.

As used herein, “extended reality” may refer to a form of electronic-based reality that has been manipulated in some manner before presentation to a user, including, for example, virtual reality (VR), augmented reality (AR), mixed reality (MR), hybrid reality, simulated reality, immersive reality, holography, or any combination thereof. For example, “extended reality” content may include completely computer-generated content or partially computer-generated content combined with captured content (e.g., real-world images). In particular embodiments, the “extended reality” content may also include video, audio, haptic feedback, or some combination thereof, any of which may be presented in a single channel or in multiple channels (such as stereo video that produces a three-dimensional (3D) effect to the viewer). Furthermore, as used herein, it should be appreciated that “extended reality” may be associated with applications, products, accessories, services, or a combination thereof, that, for example, may be utilized to create content in extended reality and/or utilized in (e.g., perform activities) an extended reality. Thus, “extended reality” content may be implemented on various platforms, including a head-mounted device (HIVID) connected to a host computer system, a standalone HMD, a mobile device or computing system, or any other hardware platform capable of providing extended reality content to one or more viewers. In particular embodiments, in which the HMD includes, for example, lightweight XR glasses or spectacles as opposed to more robust headset devices, the XR glasses or spectacles may, in comparison, include reduced processing power, low-resolution/low-cost cameras, and/or relatively simple tracking optics. Additionally, due to the smaller architectural area, the XR glasses or spectacles may also include reduced power management (e.g., batteries, battery size) and thermal management (e.g., cooling fans, heat sinks) electronics.

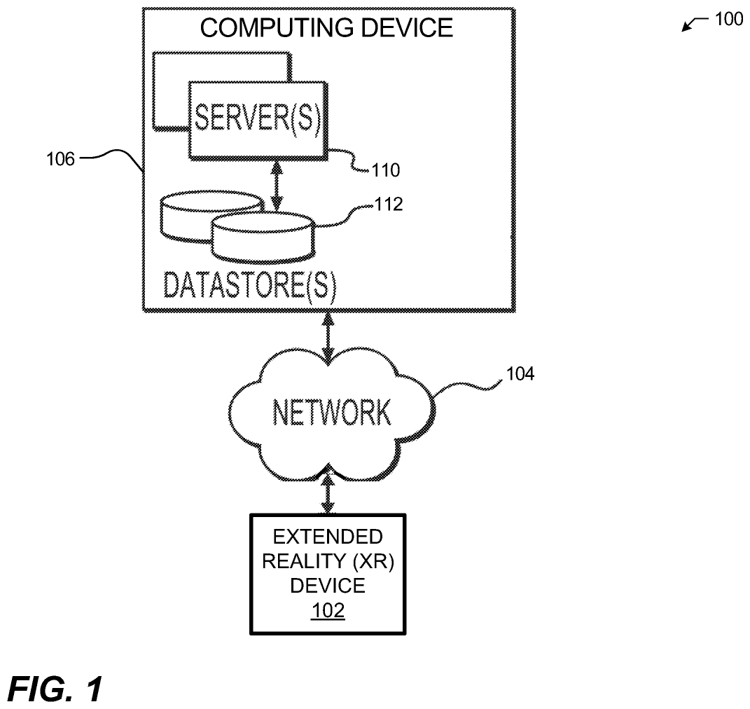

FIG. 1 illustrates an example extended reality (XR) system 100 that may be suitable for selectively re-projecting depth maps based on image and depth data and pose data updates, in accordance with presently disclosed embodiments. In particular embodiments, the XR system 100 may include an XR device 102, a network 104, and a computing platform 106. In particular embodiments, a user may wear the XR device 102 that may display visual extended reality content to the user. The XR device 102 may include an audio device that may provide audio extended reality content to the user. In particular embodiments, the XR device 102 may include one or more cameras which can capture images and videos of environments. The XR device 102 may include an eye tracking system to determine the vergence distance of the user. In particular embodiments, the XR device 102 may include a lightweight head-mounted display (HMD) (e.g., goggles, eyeglasses, spectacles, a visor, and so forth). In particular embodiments, the XR device 102 may also include a non-HMD device, such as a lightweight handheld display device or one or more laser projecting spectacles (e.g., spectacles that may project a low-powered laser onto a user's retina to project and display image or depth content to the user). In particular embodiments, the network 104 may include, for example, any of various wireless communications networks (e.g., WLAN, WAN, PAN, cellular, WMN, WiMAX, GAN, 6LowPAN, and so forth) that may be suitable for communicatively coupling the XR device 102 to the computing platform 106.

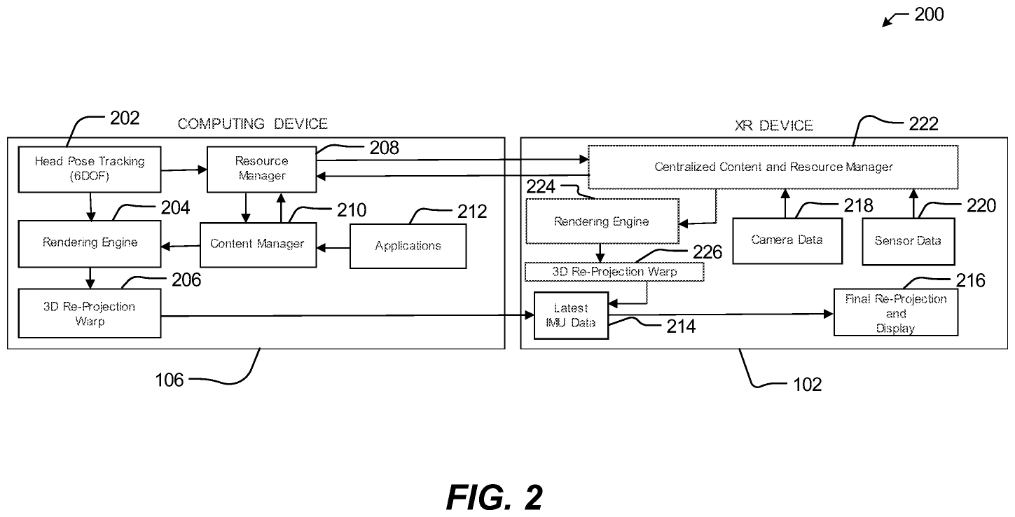

In particular embodiments, the computing platform 106 may include, for example, a standalone host computing system, an on-board computer system integrated with the XR device 102, a mobile device, or any other hardware platform that may be capable of providing extended reality content to the XR device 102. In particular embodiments, the computing platform 106 may include, for example, a cloud-based computing architecture (including one or more servers 108 and data stores 110) suitable for hosting and servicing XR applications or experiences executing on the XR device 102. For example, in particular embodiments, the computing platform 106 may include a Platform as a Service (PaaS) architecture, a Software as a Service (SaaS) architecture, and an Infrastructure as a Service (IaaS), or other similar cloud-based computing architecture. As it may be appreciated, in particular embodiments in which the XR device 102 includes lightweight devices, such as goggles, eyeglasses, spectacles, a visor, and so forth, the XR device 102 may, due to the smaller architectural area, include reduced power management (e.g., batteries, battery size) and thermal management (e.g., cooling fans, heat sinks) electronics. Thus, as will be further appreciated with respect to FIGS. 2, 3, 4A, and 4B, it may be useful to provide various rendering workload management techniques that may be utilized by a device for reducing the processing capacity, power consumption, and thermal impact as the device renders and displays frames to a user.

FIG. 2 illustrates a detailed embodiment of an extended reality (XR) system 200 for providing various rendering workload management techniques that may be utilized by a device for reducing the processing capacity, power consumption, and thermal impact as the device renders and displays frames to a user, in accordance with presently disclosed embodiments. As depicted, the computing device 106 may include a head pose tracking functional block 202, a rendering engine 204, a 3D re-projection warping functional block 206, a resource manager 208, a content manager 210, and applications 212. In particular embodiments, the computing device 106 may generate frames corresponding to a sequence of image frames (e.g., (R)ed, (B)lue, (G)reen image data) via the rendering engine 204. In particular embodiments, the computing device 106 may also access one or more depth maps corresponding to the frames. In particular embodiments, as further depicted, the computing device 106 may also maintain and keep track of pose information (e.g., head pose data, object pose data) of one or more objects within the frames calculated by the head pose functional block 210 and pose data received from the XR device 102.

In particular embodiments, the computing device 106 may host and service applications 212, which may include, for example, XR experiences executing on the XR device 102. For example, in particular embodiments, the applications 212 may include, for example, XR applications, such as video gaming applications (e.g., single-player games, multi-player games, first-person point of view (POV) games), mapping applications, music playback applications, video-sharing platform applications, video-streaming applications, e-commerce applications, social media applications, user interface (UI) applications, or other XR applications users 102 may experience. In particular embodiments, as further depicted by FIG. 2, the applications 212 or other XR content may be analyzed and managed by way of the content manager 208. For example, in particular embodiments, the content manager may include, for example, any system (e.g., software system, frameworks, compositors, or other forms of middleware/runtime systems that manage scenes displayed by the XR device 102) that may be utilized to analyze and manage 3D content associated with the applications 212 to be rendered and displayed by the XR device 102. Similarly, the resource manager 210 may include, for example, any system (e.g., software system) that keeps track of the available hardware and/or software components for hosting and servicing the applications 212 or other XR content.

In particular embodiments, as further depicted by FIG. 2, the computing device 106 may render frames (e.g., RGB-D frames) corresponding to the applications 212 or other XR content utilizing the rendering engine 204. In particular embodiments, the rendering engine 204 may then output the rendered frames to the 3D re-projection warping functional block 206, which may be utilized to compensate for network latency for the viewpoint change in that the rendered frames are provided over the network 104 to the XR device 102. In particular embodiments, as further depicted, the rendered and warped frames may be then passed from the 3D re-projection warping functional block 206 over the network 104 to a latest IMU functional block 214 of the XR device 102. In particular embodiments, the latest IMU functional block 214 may be utilized to associate the rendered and warped frames with the latest user head pose data and object pose data (e.g., real-time or near real-time head pose data and/or object pose data), for example, and re-project and display the frames 216 on the one or more displays of the XR device 102 to be interacted with by a user of the XR device 102.

In particular embodiments, as previously discussed above with respect to FIG. 1, in instances in which the XR device 102 includes, for example, lightweight XR glasses and/or other wearable electronic devices as opposed to more robust headset devices, the XR device 102 may, in comparison, include reduced processing power, low-resolution cameras, and/or relatively simple tracking optics. Additionally, due to the smaller architectural area, the XR device 102 may also include reduced power management (e.g., batteries, battery size) and thermal management (e.g., cooling fans, heat sinks) electronics. Indeed, the XR device 102 may include power and thermal limits, such that if the limits are exceeded, the XR device 102 may either shutdown, violate ergonomic or safety temperature limits, or drain the battery and significantly reduce its runtime. Thus, without the presently disclosed embodiments of providing rendering workload management techniques for reducing the processing capacity, power consumption, and thermal impact as the XR device 102 renders and displays frames to a user, the XR device 102 would otherwise be precluded from maximizing performance while reducing power consumption and thermal impact. For example, in certain embodiments, the XR device 102 may have to take actions to stay within power and thermal limits. For example, the XR device 102 may have to reduce display frame rate or, in some instances, resort to a shutdown (e.g., powering off). These actions would have highly visible and jarring impact on quality and may be adversely impact the user experience. Thus, the present embodiments enable the XR device 102 to stay within limits while maintaining the best image quality and user experience.

For example, as further depicted by FIG. 2, in particular embodiments, the XR device 102 may include a centralized content and resource manager 222 (e.g., content and scene manager) that may be utilized to perform various rendering workload management techniques for reducing the processing capacity, power consumption, and thermal impact as the XR device 102 renders and displays frames to a user. It should be appreciated that while the centralized content and resource manager 222 is displayed as being implemented on the XR device 102, in some embodiments, the centralized content and resource manager 222 can either reside on the computing device 106 or the XR device 102, or be split and shared between the computing device 106 and the XR device 102. For example, in some embodiments, the centralized content and resource manager 222 can be implemented in a software module as part of framework or be distributed between software and firmware modules. In some embodiments, the present rendering workload management techniques may be performed by the centralized content and resource manager 222 of the XR device 102 and post-rendering with respect to the computing device 106 (e.g., after frames are generated and rendered by the rendering engine 204 of the computing device 106 and provided to the XR device 102). In other embodiments, the present rendering workload management techniques may be performed by the centralized content and resource manager 222 while a rendering and displaying of one or more frames (e.g., RGB-D frames) is already in-progress (e.g., in real-time or near real-time). Still, in other embodiments, the present rendering workload management techniques may be orchestrated solely by the centralized content and resource manager 222 of the XR device 102 and performed by the rendering engine 224 of the XR device 102 or by the rendering engine 204 of the computing device 106.

For example, in particular embodiments, the content manager 208 and/or resource manager 210 of the computing device 106 may provide, to the centralized content and resource manager 222, a request for frames (e.g., RGB-D frames) associated with one or more applications 212 to be rendered and displayed by the XR device 102, and the centralized content and resource manager 222 may then determine the manner in which to render and display the requested frames (e.g., RGB-D frames). The centralized content and resource manager 222 may then carry out the rendering and displaying of the requested frames (e.g., RGB-D frames) by instructing and utilizing the rendering engine 224 and 3D re-projection warp functional block 226. In one example embodiment, the centralized content and resource manager 222 may include, for example, any system (e.g., software system) that may be utilized to analyze, process, and manage frames of XR content to be rendered and displayed by the XR device 102. In another example embodiment, the centralized content and resource manager 222 may include, for example, any system (e.g., software system) that maintains and keeps track of the available hardware resources and/or software resources (e.g., power budgets, thermal budgets, camera data 218, sensor data 220, processing capacity, memory capacity, power consumption, processing time, network 104 bandwidth, network 104 latency, network 104 data throughput, network 104 quality, and so forth) to be utilized for rendering and displaying frames of XR content on the XR device 102.

In particular embodiments, in accordance with the presently disclosed techniques, the centralized content and resource manager 222 may receive a request to render one or more frames (e.g., RGB-D frames) from the computing device 106. For example, in particular embodiments, the centralized content and resource manager 222 may receive a request to render one or more frames (e.g., RGB-D frames) corresponding to applications 212 or other XR content. In particular embodiments, the centralized content and resource manager 222 may determine associated image characteristic with respect to each object of the content of the one or more frames (e.g., RGB-D frames). For example, in particular embodiments, the centralized content and resource manager 222 may determine with respect to each object of the content of the one or more frames (e.g., RGB-D frames) a foveal region (e.g., based on camera data 218, the centralized content and resource manager 222 may determine and distinguish objects and content that are to be viewable in a foveal region of the user as opposed objects and content that may appear along the periphery of the user's view), an object dimension (e.g., the centralized content and resource manager 222 may determine and distinguish 3D objects and content from 2D objects and content), a viewing distance (e.g., distance away from the viewer), user interaction (e.g., a game may involve the user interacting with only certain objects while avoiding other objects), and so forth.

In particular embodiments, the centralized content and resource manager 222 may then determine whether to reduce a rendering workload associated with rendering the one or more frames (e.g., RGB-D frames) to satisfy one or more power, processing, or thermal constraints associated with the XR device 102. For example, in particular embodiments, the one or more power, processing, or thermal constraints (e.g., power consumption constraint, thermal operating temperature constraint, processing speed constraint, memory capacity, and so forth) may be predetermined for the XR device 102, the computing device 106, or both, and the XR device 102 may then monitor, for example, device operating temperature, ambient temperature, lighting variation (e.g., daylight as compared to night), processing workload, power consumption (e.g., battery usage, battery charge), time the XR device 102 is awake vs. asleep, user activity, and so forth and provide the monitored data as sensor data 220 to the centralized content and resource manager 222. In one example embodiment, the one or more power, processing, or thermal constraints may be predetermined and fixed over time. In another example embodiment, the one or more power, processing, or thermal constraints may be dynamic and change over time based on the rendering workload of the XR device 102, the specific application 212, and/or one or more environmental conditions (e.g., daytime vs. nighttime, cooler day vs. hotter day, ambient lighting, indoor vs. outdoor, and so forth) with respect to where in which the user may be utilizing the XR device 102.

In particular embodiments, in response to a determination to reduce the rendering workload, the centralized content and resource manager 222 may then generate a set of rending parameters for rendering the one or more frames (e.g., RGB-D frames) in order to reduce the rendering workload. In particular embodiments, at least one rendering parameter in the set of rendering parameters may be determined based on the characteristic (e.g., foveal region, 2D vs. 3D object dimensions, viewing distance, user interaction, and so forth) associated with each object of the content of the one or more frames (e.g., RGB-D frames) to be rendered and displayed. For example, in particular embodiments, the centralized content and resource manager 222 may generate the set of rendering parameters by generating one or more of a suspended object surface, an altered viewport, an altered frame rate (e.g., as expressed in frames per second (FPS)), an altered resolution, an altered bit depth, an altered one or more color channels (e.g., on a per color channel basis, the centralized content and resource manager 222 may display RGB frames as all red, all blue, or all green, respectively; scale down each color channel by 33%; scale down the red color channel by 50% while scaling down the blue and green color channels by only 25%; and so forth and so on), an altered pose update threshold (e.g., the centralized content and resource manager 222 may define a head pose range in which as long as the user's head stays within the defined range, a previous one or more frames may be re-rendered), an altered depth continuity, an altered content range, an altered depth density, an altered near-field depth, an altered far-field depth, an altered brightness, an altered contrast, or an altered tone, and so forth. In another embodiment, the content of the one or more frames (e.g., RGB-D frames) may be labeled with one or more metadata that inform the centralized content and resource manager 222 of a desired QoS to utilize to render that particular content.

In particular embodiments, the centralized content and resource manager 222 may then cause the one or more frames (e.g., RGB-D frames) to be rendered by the rendering engine 224 in accordance with the set of rending parameters so as to satisfy the one or more power, processing, or thermal constraints. It should be appreciated that same would apply if the content was rendered on the computing device 106, managers 206 and 208 would set rendering parameters and the rendering engine 204 would render accordingly. In particular embodiments, the rendering engine 224 may then output the rendered frames to the 3D re-projection warping functional block 226. The rendered and warped frames may be then passed from the 3D re-projection warping functional block 226 to the latest IMU functional block 214 to associate the rendered and warped frames with the latest user head pose data and object pose data, and re-project and display the frames 216 on the one or more displays of the XR device 102.

In particular embodiments, in accordance with the foregoing rendering workload management techniques, the centralized content and resource manager 222 may further receive a request to render one or more frames (e.g., RGB-D frames) that may correspond, for example, to applications 212. In particular embodiments, the centralized content and resource manager 222 may then determine performance capacity at which an application 212 can execute without violating power and thermal constraints. In some embodiments this performance level is determined reactively using current power and thermal conditions in the system. For example, as power and temperature reach limits specified by the system, performance capacity needs to be reduced. In other embodiments, the centralized content and resource manager 222 may generate a prediction of workload duration and select performance capacity that will not violate power and thermal limits for the duration of the workload. In this embodiment, the centralized content and resource manager 222 ensures that the system is able to maximize performance while providing a user with stable level of performance and quality. The centralized content and resource manager 222 may generate this prediction when a user starts an application 212. In some embodiments, the prediction of workload duration can be based on prior application history or other (user/app/system) contextual information.

Performance capacity specifies the level of performance that can be delivered by the system. In one embodiment, this level of performance is based on immediate power/thermal conditions and specifies performance capacity for a short duration. This performance capacity is likely to change as workload continues executing. In other embodiments, this level of performance is based on workload duration prediction and thus predicts performance capacity over longer time for the entire workload duration. This performance capacity shows the level of sustained performance that the system can deliver for the duration of the workload without violating power and thermal limits.

In one embodiment, performance capacity includes rendering engine performance 204 of the computing device 106. In other embodiments, performance capacity may include performance of the reprojection warp performance 226 of the XR device 102 or other elements of the GFX pipeline between computing device 106 and XR device 102 including wireless network and display.

In particular embodiments, the centralized content and resource manager 222 may then generate a prediction of a duration for rendering the one or more frames (e.g., RGB-D frames) based on a current rendering workload of the XR device 102 and current performance capacity. For example, in one embodiment, the centralized content and resource manager 222 may generate the prediction of a duration for rendering the one or more frames (e.g., RGB-D frames) based on one or more parameters or instructions that may be associated with the particular applications 212. In another embodiment, the centralized content and resource manager 222 may utilize one or more machine-learning algorithms to learn or determine heuristically over time the duration in which one or more frames (e.g., RGB-D frames) associated with particular applications 212 may be rendered with as best as possible QoS and in view of the current performance capacity. In another embodiment, the centralized content and resource manager 222 may generate the prediction of the duration for rendering the one or more frames (e.g., RGB-D frames) based on a user context or an amount of user interaction that may be associated with a particular application (e.g., single-player gaming application, multi-player gaming application).

In particular embodiments, the centralized content and resource manager 222 may then select one of a plurality of predetermined rendering workload modes based on the prediction of the duration for rendering the one or more frames (e.g., RGB-D frames). For example, in particular embodiments, the plurality of predetermined rendering workload modes may include a high-performance rendering workload mode, a medium performance workload processing mode, and a low performance rendering workload mode. For example, in some embodiments, the centralized content and resource manager 222 may map the predicted rendering workload to the determined processing performance capacity to render the one or more frames (e.g., RGB-D frames) with as best as possible QoS and in view of the one or more power, processing, or thermal constraints. In particular embodiments, the centralized content and resource manager 222 may then cause the rendering engine 224 render the frame in accordance with the selected one of the plurality of predetermined rendering workload modes so as to satisfy the one or more power, processing, or thermal constraints used to determine system performance capacity. For example, one or more 2D frames (e.g., RGB frames) corresponding to, for example, an application with a shorter predicted duration (e.g., runtime of only a few minutes) may be rendered in accordance with the high performance rendering workload mode. In contrast, one or more 3D frames (e.g., RGB-D frames) corresponding to, for example, a gaming application (e.g., which may also include considerable user interaction) with a longer predicted duration (e.g., runtime of 30 minutes or more or a runtime of 1 hour or more) may be rendered in accordance with the low performance rendering workload mode.

In particular embodiments, in accordance with the foregoing rendering workload management techniques, the centralized content and resource manager 222 may further receive a request to render one or more frames (e.g., RGB-D frames) that may correspond, for example, to applications 212. In particular embodiments, as previously noted above the XR device 102 may receive requests or other data from the computing device 106 over a network 104. In particular embodiments, the XR device 102 may include one or more first processors (e.g., one or more first graphic processing units (GPUs)) for driving the rendering engine 224, and, similarly, the computing device 106 may include one or more second processors (e.g., one or more second GPUs) for driving the rendering engine 204. For example, in particular embodiments, the XR device 102 and the computing device 106 may be suitable for supporting, for example, distributed graphics pipeline (e.g., the one or more first GPUs of the XR device 102 and the one or more second GPUs of the computing device 106 transferring data over the s network 104). Thus, in one example embodiment, one or more frames may be rendered either utilizing the rendering engine 224 and associated first one or more GPUs of the XR device 102 or utilizing the rendering engine 204 and associated second one or more GPUs of the computing device 106.

In particular embodiments, the first one or more GPUs of the XR device 102 may include less processing power or support a subset of rendering features/capabilities as compared to the second one or more GPUs of the computing device 106. In particular embodiments, the centralized content and resource manager 222 may determine a rendering workload associated with rendering the one or more frames (e.g., RGB-D frames) to satisfy one or more power, processing, or thermal constraints associated with the XR device 102 and a target QoS with respect to the network 104 communicatively coupling the computing device 106 and the XR device 102. In particular embodiments, the centralized content and resource manager 222 may then dynamically switch between rendering the one or more frames (e.g., RGB-D frames) utilizing the rendering engine 224 and associated one or more first GPUs of the XR device 102 and rendering the one or more frames (e.g., RGB-D frames) utilizing the rendering engine 204 and associated one or more second GPUs of the computing device 106 based on the one or more power, processing, or thermal constraints and the target QoS.

For example, in particular embodiments, the centralized content and resource manager 222 may monitor the condition of the network 104 (e.g., network 104 latency, network 104 quality, network 104 bandwidth, network 104 data throughput, and so forth) with respect to the determined rendering workload associated with rendering the one or more frames (e.g., RGB-D frames). For example, in some embodiments, the one or more frames (e.g., RGB-D frames) may include XR content that may be latency sensitive (e.g., world-locked XR content may be constantly updated as the user's head pose changes). In accordance with the presently disclosed embodiments, the centralized content and resource manager 222 may thus analyze the XR content of the one or more frames (e.g., RGB-D frames), and, based on the condition of the network 104 and the determined rendering workload associated with rendering the one or more frames (e.g., RGB-D frames), dynamically switch between rendering the one or more frames (e.g., RGB-D frames) utilizing the rendering engine 224 and associated one or more first GPUs of the XR device 102 and rendering the one or more frames (e.g., RGB-D frames) utilizing the rendering engine 204 and associated one or more second GPUs of the computing device 106.

Thus, in accordance with the foregoing embodiments, the present techniques may provide various rendering workload management techniques that may be utilized by a device for reducing the processing capacity, power consumption, and thermal impact as the device renders and displays frames to a user. For example, the present techniques may be provided to alter parameters of the rendering workload of the device and to determine when, and the manner in which, to alter parameters of the rendering workload of the device in accordance with predetermined processing capacity constraints, power consumption constraints, and thermal constraints. In this way, the device pipeline may be optimized to operate at the highest energy efficiency level and may reduce overall power consumption and thermal impact by dynamically managing the rendering workload.

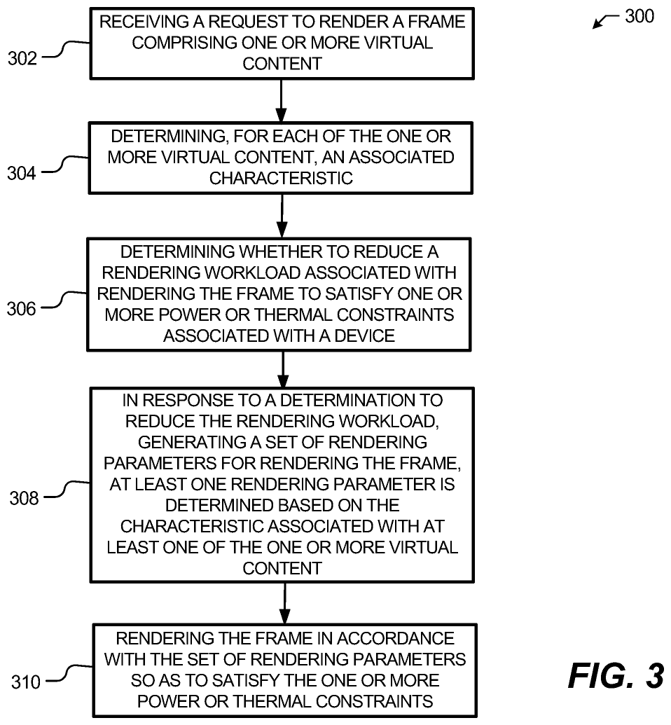

FIG. 3 illustrates a flow diagram of a method 300 for providing rendering workload management techniques for reducing processing capacity, power consumption, and thermal impact of a device based on generating a set of rending parameters for rendering the frame in order to reduce the rendering workload, in accordance with presently disclosed techniques. The method 300 may be performed utilizing one or more processing devices (e.g., XR device 102) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof

The method 300 may begin at block 302 with one or more processing devices (e.g., XR device 102) receiving a request to render a frame comprising one or more virtual content. The method 300 may then continue at block 304 with the one or more processing devices (e.g., XR device 102) determining, for each of the one or more virtual content, an associated characteristic. The method 300 may then continue at block 306 with the one or more processing devices (e.g., XR device 102) determining whether to reduce a rendering workload associated with rendering the frame to satisfy one or more power or thermal constraints associated with the device. The method 300 may then continue at block 308 with the one or more processing devices (e.g., XR device 102), in response to a determination to reduce the rendering workload, generating a set of rending parameters for rendering the frame in order to reduce the rendering workload, wherein at least one rendering parameter in the set of rendering parameters is determined based on the characteristic associated with at least one of the one or more virtual content. The method 300 may then conclude at block 310 with the one or more processing devices (e.g., XR device 102) rendering the frame in accordance with the set of rending parameters so as to satisfy the one or more power or thermal constraints.

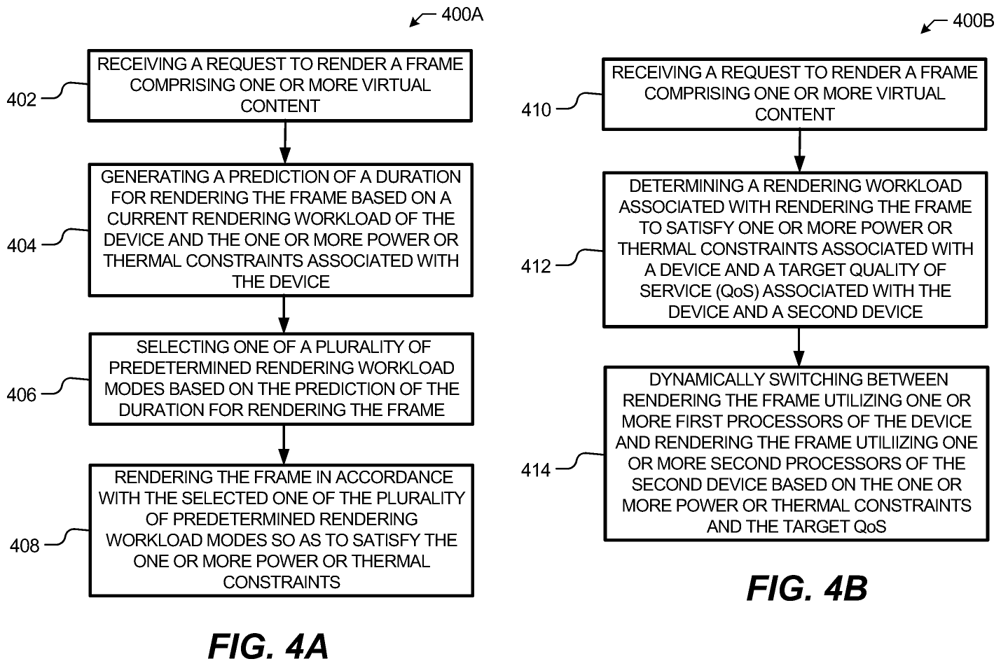

FIG. 4A illustrates a flow diagram of a method 400A for providing rendering workload management techniques for reducing processing capacity, power consumption, and thermal impact of a device based on generating a prediction of a duration for rendering a frame, in accordance with presently disclosed techniques. The method 400 may be performed utilizing one or more processing devices (e.g., XR device 102) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 400A may begin at block 402 with one or more processing devices (e.g., XR device 102) receiving a request to render a frame comprising one or more virtual content. The method 400A may then continue at block 404 with the one or more processing devices (e.g., XR device 102) generating a prediction of a duration for rendering the frame based on a current rendering workload of a device and one or more power or thermal constraints associated with the device. The method 400A may then continue at block 406 with the one or more processing devices (e.g., XR device 102) selecting one of a plurality of predetermined rendering workload modes based on the prediction of the duration for rendering the frame. The method 400A may then conclude at block 408 with the one or more processing devices (e.g., XR device 102) rendering the frame in accordance with the selected one of the plurality of predetermined rendering workload modes so as to satisfy the one or more power or thermal constraints.

FIG. 4B illustrates a flow diagram of a method 400B for providing rendering workload management techniques for reducing processing capacity, power consumption, and thermal impact of a device based on dynamically switching GPUs for rendering a frame, in accordance with presently disclosed techniques. The method 400B may be performed utilizing one or more processing devices (e.g., XR device 102) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 400B may begin at block 410 with one or more processing devices (e.g., XR device 102) receiving a request to render a frame comprising one or more virtual content. The method 400B may then continue at block 412 with the one or more processing devices (e.g., XR device 102) determining a rendering workload associated with rendering the frame to satisfy one or more power or thermal constraints associated with a device and a target quality of service (QoS) associated with the device and the second device. The method 400B may then conclude at block 414 with the one or more processing devices (e.g., XR device 102) dynamically switching between rendering the frame utilizing the one or more first processors and rendering the frame utilizing the one or more second processors based on the one or more power or thermal constraints and the target QoS.

Accordingly, as described by the method 300 of FIG. 3 and the method 400A and the method 400B of FIGS. 4A and 4B, respectively, the present techniques are directed toward providing various rendering workload management techniques that may be utilized by a device for reducing the processing capacity, power consumption, and thermal impact as the device renders and displays frames to a user. For example, the present techniques may be provided to alter parameters of the rendering workload of the device and to determine when, and the manner in which, to alter parameters of the rendering workload of the device in accordance with predetermined processing capacity constraints, power consumption constraints, and thermal constraints. In this way, the device pipeline may be optimized to operate at the highest energy efficiency level and may reduce overall power consumption and thermal impact by dynamically managing the rendering workload.

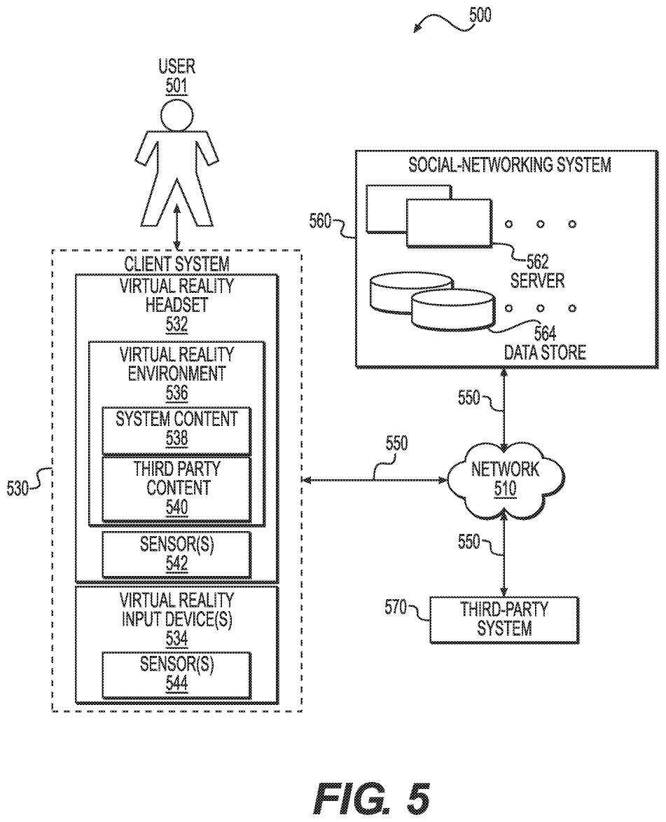

FIG. 5 illustrates an example network environment 500 associated with an extended reality (XR) system. Network environment 500 includes a user 501 interacting with a client system 530, a social-networking system 560, and a third-party system 570 connected to each other by a network 510. Although FIG. 5 illustrates a particular arrangement of a user 501, a client system 530, a social-networking system 560, a third-party system 570, and a network 510, this disclosure contemplates any suitable arrangement of a user 501, a client system 530, a social-networking system 560, a third-party system 570, and a network 510. As an example, and not by way of limitation, two or more of users 501, a client system 530, a social-networking system 560, and a third-party system 570 may be connected to each other directly, bypassing a network 510. As another example, two or more of client systems 530, a social-networking system 560, and a third-party system 570 may be physically or logically co-located with each other in whole or in part. Moreover, although FIG. 5 illustrates a particular number of users 501, client systems 530, social-networking systems 560, third-party systems 570, and networks 510, this disclosure contemplates any suitable number of client systems 530, social-networking systems 560, third-party systems 570, and networks 510. As an example, and not by way of limitation, network environment 500 may include multiple users 501, client systems 530, social-networking systems 560, third-party systems 570, and networks 510.

This disclosure contemplates any suitable network 510. As an example, and not by way of limitation, one or more portions of a network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 510 may include one or more networks 510. Links 550 may connect a client system 530, a social-networking system 560, and a third-party system 570 to a communication network 510 or to each other. This disclosure contemplates any suitable links 550. In particular embodiments, one or more links 550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout a network environment 500. One or more first links 550 may differ in one or more respects from one or more second links 550.

In particular embodiments, a client system 530 may be an electronic device including hardware, software, or embedded logic components or a combination of two or more such components and capable of carrying out the appropriate functionalities implemented or supported by a client system 530. As an example, and not by way of limitation, a client system 530 may include a computer system such as a desktop computer, notebook or laptop computer, netbook, a tablet computer, e-book reader, GPS device, camera, a digital assistant (PDA), handheld electronic device, cellular telephone, smartphone, virtual reality headset and controllers, other suitable electronic device, or any suitable combination thereof. This disclosure contemplates any suitable client systems 530. A client system 530 may enable a network user at a client system 530 to access a network 510. A client system 530 may enable its user to communicate with other users at other client systems 530. A client system 530 may generate a virtual reality environment for a user to interact with content.

In particular embodiments, a client system 530 may include a virtual reality (or augmented reality) headset 532, and virtual reality input device(s) 534, such as a virtual reality controller. A user at a client system 530 may wear the virtual reality headset 532 and use the virtual reality input device(s) to interact with a virtual reality environment 536 generated by the virtual reality headset 532. Although not shown, a client system 530 may also include a separate processing computer and/or any other component of a virtual reality system. A virtual reality headset 532 may generate a virtual reality environment 536, which may include system content 538 (including but not limited to the operating system), such as software or firmware updates and also include third-party content 540, such as content from applications or dynamically downloaded from the Internet (e.g., web page content). A virtual reality headset 532 may include sensor(s) 542, such as accelerometers, gyroscopes, magnetometers to generate sensor data that tracks the location of the headset device 532. The headset 532 may also include eye trackers for tracking the position of the user's eyes or their viewing directions. The client system may use data from the sensor(s) 542 to determine velocity, orientation, and gravitation forces with respect to the headset.

Virtual reality input device(s) 534 may include sensor(s) 544, such as accelerometers, gyroscopes, magnetometers, and touch sensors to generate sensor data that tracks the location of the input device 534 and the positions of the user's fingers. The client system 530 may make use of outside-in tracking, in which a tracking camera (not shown) is placed external to the virtual reality headset 532 and within the line of sight of the virtual reality headset 532. In outside-in tracking, the tracking camera may track the location of the virtual reality headset 532 (e.g., by tracking one or more infrared LED markers on the virtual reality headset 532). Alternatively, or additionally, the client system 530 may make use of inside-out tracking, in which a tracking camera (not shown) may be placed on or within the virtual reality headset 532 itself In inside-out tracking, the tracking camera may capture images around it in the real world and may use the changing perspectives of the real world to determine its own position in space.

Third-party content 540 may include a web browser, such as MICROSOFT INTERNET EXPLORER, GOOGLE CHROME or MOZILLA FIREFOX, and may have one or more add-ons, plug-ins, or other extensions, such as TOOLBXR or YAHOO TOOLBXR. A user at a client system 530 may enter a Uniform Resource Locator (URL) or other address directing a web browser to a particular server (such as server 562, or a server associated with a third-party system 570), and the web browser may generate a Hyper Text Transfer Protocol (HTTP) request and communicate the HTTP request to server. The server may accept the HTTP request and communicate to a client system 530 one or more Hyper Text Markup Language (HTML) files responsive to the HTTP request. The client system 530 may render a web interface (e.g. a webpage) based on the HTML files from the server for presentation to the user. This disclosure contemplates any suitable source files. As an example, and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 560 may be a network-addressable computing system that may host an online social network. The social-networking system 560 may generate, store, receive, and send social-networking data, such as, for example, user-profile data, concept-profile data, social-graph information, or other suitable data related to the online social network. The social-networking system 560 may be accessed by the other components of network environment 500 either directly or via a network 510. As an example, and not by way of limitation, a client system 530 may access the social-networking system 560 using a web browser of a third-party content 540, or a native application associated with the social-networking system 560 (e.g., a mobile social-networking application, a messaging application, another suitable application, or any combination thereof) either directly or via a network 510. In particular embodiments, the social-networking system 560 may include one or more servers 562. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof

In particular embodiments, each server 562 may include hardware, software, or embedded logic components or a combination of two or more such components for carrying out the appropriate functionalities implemented or supported by server 562. In particular embodiments, the social-networking system 560 may include one or more data stores 564. Data stores 564 may be used to store various types of information. In particular embodiments, the information stored in data stores 564 may be organized according to specific data structures. In particular embodiments, each data store 564 may be a relational, columnar, correlation, or other suitable database. Although this disclosure describes or illustrates particular types of databases, this disclosure contemplates any suitable types of databases. Particular embodiments may provide interfaces that enable a client system 530, a social-networking system 560, or a third-party system 570 to manage, retrieve, modify, add, or delete, the information stored in data store 564.

In particular embodiments, the social-networking system 560 may store one or more social graphs in one or more data stores 564. In particular embodiments, a social graph may include multiple nodes—which may include multiple user nodes (each corresponding to a particular user) or multiple concept nodes (each corresponding to a particular concept)—and multiple edges connecting the nodes. The social-networking system 560 may provide users of the online social network the ability to communicate and interact with other users. In particular embodiments, users may join the online social network via the social-networking system 560 and then add connections (e.g., relationships) to a number of other users of the social-networking system 560 whom they want to be connected to. Herein, the term “friend” may refer to any other user of the social-networking system 560 with whom a user has formed a connection, association, or relationship via the social-networking system 560.

In particular embodiments, the social-networking system 560 may provide users with the ability to take actions on various types of items or objects, supported by the social-networking system 560. As an example, and not by way of limitation, the items and objects may include groups or social networks to which users of the social-networking system 560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 560 or by an external system of a third-party system 570, which is separate from the social-networking system 560 and coupled to the social-networking system 560 via a network 510.

In particular embodiments, the social-networking system 560 may be capable of linking a variety of entities. As an example, and not by way of limitation, the social-networking system 560 may enable users to interact with each other as well as receive content from third-party systems 570 or other entities, or to allow users to interact with these entities through an application programming interfaces (API) or other communication channels. In particular embodiments, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating the social-networking system 560. In particular embodiments, however, the social-networking system 560 and third-party systems 570 may operate in conjunction with each other to provide social-networking services to users of the social-networking system 560 or third-party systems 570. In this sense, the social-networking system 560 may provide a platform, or backbone, which other systems, such as third-party systems 570, may use to provide social-networking services and functionality to users across the Internet.

In particular embodiments, a third-party system 570 may include a third-party content object provider. A third-party content object provider may include one or more sources of content objects, which may be communicated to a client system 530. As an example, and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 560 also includes user-generated content objects, which may enhance a user's interactions with the social-networking system 560. User-generated content may include anything a user may add, upload, send, or “post” to the social-networking system 560. As an example, and not by way of limitation, a user communicates posts to the social-networking system 560 from a client system 530. Posts may include data such as status updates or other textual data, location information, photos, videos, links, music or other similar data or media. Content may also be added to the social-networking system 560 by a third-party through a “communication channel,” such as a newsfeed or stream. In particular embodiments, the social-networking system 560 may include a variety of servers, sub-systems, programs, modules, logs, and data stores. In particular embodiments, the social-networking system 560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 560 may also include suitable components such as network interfaces, security mechanisms, load balancers, failover servers, management-and-network-operations consoles, other suitable components, or any suitable combination thereof.

In particular embodiments, the social-networking system 560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example, and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 560 to one or more client systems 530 or one or more third-party systems 570 via a network 510. The web server may include a mail server or other messaging functionality for receiving and routing messages between the social-networking system 560 and one or more client systems 530. An API-request server may allow a third-party system 570 to access information from the social-networking system 560 by calling one or more APIs. An action logger may be used to receive communications from a web server about a user's actions on or off the social-networking system 560.

In conjunction with the action log, a third-party-content-object log may be maintained of user exposures to third-party-content objects. A notification controller may provide information regarding content objects to a client system 530. Information may be pushed to a client system 530 as notifications, or information may be pulled from a client system 530 responsive to a request received from a client system 530. Authorization servers may be used to enforce one or more privacy settings of the users of the social-networking system 560. A privacy setting of a user may determine how particular information associated with a user may be shared. The authorization server may allow users to opt in to or opt out of having their actions logged by the social-networking system 560 or shared with other systems (e.g., a third-party system 570), such as, for example, by setting appropriate privacy settings. Third-party-content-object stores may be used to store content objects received from third parties, such as a third-party system 570. Location stores may be used for storing location information received from client systems 530 associated with users. Advertisement-pricing modules may combine social information, the current time, location information, or other suitable information to provide relevant advertisements, in the form of notifications, to a user.

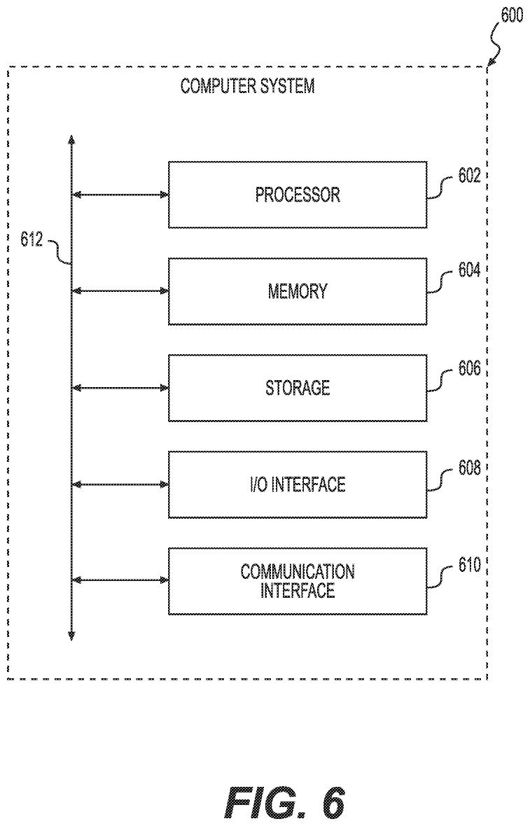

FIG. 6 illustrates an example computer system 600 that may be useful in performing one or more of the foregoing techniques as presently disclosed herein. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein.

As an example, and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate. In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example, and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example, and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602.

Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example, and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere).

One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example, and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EXROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a user and computer system 600. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example, and not by way of limitation, communication interface 610 may include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 610 for it.

As an example, and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example, and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a user having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a user having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system of a device:
receiving a request to render a frame comprising one or more virtual content;
determining, for each of the one or more virtual content, an associated characteristic;
determining whether to reduce a rendering workload associated with rendering the frame to satisfy one or more power or thermal constraints associated with the device;
in response to a determination to reduce the rendering workload, generating a set of rending parameters for rendering the frame in order to reduce the rendering workload, wherein at least one rendering parameter in the set of rendering parameters is determined based on the characteristic associated with at least one of the one or more virtual content; and
rendering the frame in accordance with the set of rending parameters so as to satisfy the one or more power or thermal constraints.

2. The method of claim 1, wherein receiving the request to render the frame comprises receiving the request from a second device communicatively coupled to the device.

3. The method of claim 1, wherein determining, for each of the one or more virtual content, an associated characteristic comprises determining one or more of a foveal region, an object dimension, or a viewing distance.

4. The method of claim 1, wherein generating the set of rending parameters comprises generating one or more of an altered viewport, an altered frame rate, an altered resolution, an altered bit depth, an altered one or more color channels, an altered pose update threshold, an altered depth continuity, an altered content range, an altered depth density, an altered near-field depth, an altered far-field depth, an altered brightness, an altered contrast, or an altered tone.

5. The method of claim 1, further comprising:
subsequent to receiving the request to render the frame:
generating a prediction of a duration for rendering the frame based on a current rendering workload of the device and the one or more power or thermal constraints associated with the device;
selecting one of a plurality of predetermined rendering workload modes based on the prediction of the duration for rendering the frame; and
rendering the frame in accordance with the selected one of the plurality of predetermined rendering workload modes so as to satisfy the one or more power or thermal constraints.

6. The method of claim 5, wherein the plurality of predetermined rendering workload modes comprises a high performance rendering workload mode, a medium performance workload processing mode, and a low performance rendering workload mode.

7. The method of claim 1, wherein the device comprises one or more first processors and a second device comprises one or more second processors, the device being communicatively coupled to the second device, the method further comprising:
determining a rendering workload associated with rendering the frame to satisfy the one or more power or thermal constraints associated with the device and a target quality of service (QoS) associated with the device and the second device; and
dynamically switching between rendering the frame utilizing the one or more first processors and rendering the frame utilizing the one or more second processors based on the one or more power or thermal constraints and the target QoS.

8. A device, comprising:
a non-transitory computer-readable storage medium including instructions; and
one or more processors coupled to the non-transitory computer-readable storage medium, the one or more processors configured to execute the instructions to:
receive a request to render a frame comprising one or more virtual content;
determine, for each of the one or more virtual content, an associated characteristic;
determine whether to reduce a rendering workload associated with rendering the frame to satisfy one or more power or thermal constraints associated with the first device;
in response to a determination to reduce the rendering workload, generate a set of rending parameters for rendering the frame in order to reduce the rendering workload, wherein at least one rendering parameter in the set of rendering parameters is determined based on the characteristic associated with at least one of the one or more virtual content; and
render the frame in accordance with the set of rending parameters so as to satisfy the one or more power or thermal constraints.

9. The device of claim 8, wherein the instructions to receive the request to render the frame further comprises instructions to receive the request from a second device communicatively coupled to the device.

10. The device of claim 8, wherein the instructions to determine, for each of the one or more virtual content, the associated characteristic further comprises instructions to determine one or more of a foveal region, an object dimension, or a viewing distance.

11. The device of claim 8, wherein the instructions to generate the set of rending parameters comprises further comprises instructions to generate one or more of an altered viewport, an altered frame rate, an altered resolution, an altered bit depth, an altered one or more color channels, an altered pose update threshold, an altered depth continuity, an altered content range, an altered depth density, an altered near-field depth, an altered far-field depth, an altered brightness, an altered contrast, or an altered tone.

12. The device of claim 8, wherein the instructions further comprises instructions to:
subsequent to receiving the request to render the frame:
generate a prediction of a duration for rendering the frame based on a current rendering workload of the first device and the one or more power or thermal constraints associated with the first device;
select one of a plurality of predetermined rendering workload modes based on the prediction of the duration for rendering the frame; and
render the frame in accordance with the selected one of the plurality of predetermined rendering workload modes so as to satisfy the one or more power or thermal constraints.

13. The device of claim 12, wherein the plurality of predetermined rendering workload modes comprises a high performance rendering workload mode, a medium performance workload processing mode, and a low performance rendering workload mode.

14. The device of claim 8, wherein the device comprises one or more first processors and a second device comprises one or more second processors, the device being communicatively coupled to the second device, the instructions further comprising instructions to:
determine a rendering workload associated with rendering the frame to satisfy the one or more power or thermal constraints associated with the device and a target quality of service (QoS) associated with the device and the second device; and
dynamically switch between rendering the frame utilizing the one or more first processors and rendering the frame utilizing the one or more second processors based on the one or more power or thermal constraints and the target QoS.

15. A non-transitory computer-readable medium comprising instructions that, when executed by one or more processors of a device, cause the one or more processors to:
receive a request to render a frame comprising one or more virtual content;
determining, for each of the one or more virtual content, an associated characteristic;
determine whether to reduce a rendering workload associated with rendering the frame to satisfy one or more power or thermal constraints associated with the device;
in response to a determination to reduce the rendering workload, generate a set of rending parameters for rendering the frame in order to reduce the rendering workload, wherein at least one rendering parameter in the set of rendering parameters is determined based on the characteristic associated with at least one of the one or more virtual content; and
render the frame in accordance with the set of rending parameters so as to satisfy the one or more power or thermal constraints.

16. The non-transitory computer-readable medium of claim 15, wherein the instructions to receive the request to render the frame further comprises instructions to receive the request from a second device communicatively coupled to the device.

17. The non-transitory computer-readable medium of claim 15, wherein the instructions to generate the set of rending parameters comprises further comprises instructions to generate one or more of an altered viewport, an altered frame rate, an altered resolution, an altered bit depth, an altered one or more color channels, an altered pose update threshold, an altered depth continuity, an altered content range, an altered depth density, an altered near-field depth, an altered far-field depth, an altered brightness, an altered contrast, or an altered tone.

18. The non-transitory computer-readable medium of claim 15, wherein the instructions further comprises instructions to:
subsequent to receiving the request to render the frame:
generate a prediction of a duration for rendering the frame based on a current rendering workload of the first device and the one or more power or thermal constraints associated with the device;
select one of a plurality of predetermined rendering workload modes based on the prediction of the duration for rendering the frame; and
render the frame in accordance with the selected one of the plurality of predetermined rendering workload modes so as to satisfy the one or more power or thermal constraints.

19. The non-transitory computer-readable medium of claim 18, wherein the plurality of predetermined rendering workload modes comprises a high performance rendering workload mode, a medium performance workload processing mode, and a low performance rendering workload mode.

20. The non-transitory computer-readable medium of claim 15, wherein the device comprises one or more first processors and a second device comprises one or more second processors, the device being communicatively coupled to the second device, the instructions further comprising instructions to:
determine a rendering workload associated with rendering the frame to satisfy the one or more power or thermal constraints associated with the device and a target quality of service (QoS) associated with the device and the second device; and
dynamically switch between rendering the frame utilizing the one or more first processors and rendering the frame utilizing the one or more second processors based on the one or more power or thermal constraints and the target QoS.
